(19) United States
(12) Patent Application Publication
(10) Pub. No.: US 2015/0096478 A1
(43) Pub. Date: Apr. 9, 2015

(54) Safety Shelter

(71) Applicant: Armored Closet, LLC, Arlington, TX (US)

(72) Inventor: David Magiera, Arlington, TX (US)

(21) Appl. No.: 14/504,889

(22) Filed: Oct. 2, 2014

Related U.S. Application Data
(60) Provisional application No. 61/888,347, filed on Oct. 8, 2013.

(51) Int. Cl. E04H 9/06; E04H 9/14; E06B 5/10; E04H 9/04; E05G 1/026; E05G 1/024

(52) U.S. Cl. CPC E04H 9/06; E05G 1/026; E05G 1/024; E06B 5/10; E04H 9/04; E04H 9/14
USPC 109/23; 109/64

(57) ABSTRACT

The present invention comprises a modular safety shelter including one or more ceiling panels connected to one or sidewall panels which are installed in an existing closet or enclosed space in the interior of a home or other structure. The modular safety shelter includes one or more air vents, locking devices, and a light source for providing light to the occupants within the shelter when the shelter is in use. The modular safety structure is configured and built to withstand severe storm winds, impacts from flying debris and provides a safe enclosure for occupants during a home invasion or burglary event.

### CROSS-REFERENCE TO RELATED APPLICATIONS

This application claims the benefit of and priority to copending U.S. provisional patent application Ser. No. 61/888,347, filed on Oct. 8, 2013 with the United States Patent & Trademark Office the complete disclosure of which is incorporated herein by reference.

### TECHNICAL FIELD OF THE INVENTION

This invention generally relates to a safety shelter and, more particularly, to a safety shelter for installation into existing closet and other enclosed spaces in existing homes, buildings and other occupied structures.

### BACKGROUND OF THE INVENTION

Tornadoes and severe storms cause millions of dollars in damage every year to homes and other structures. Such catastrophic weather events typically cause injury and death to the persons occupying homes and other structures while seeking shelter from the flying debris and high winds which accompany such weather events. Likewise, a majority of such homes do not have a safe room in which the occupants my stay and remain safe during events such as home invasion burglaries and other violent crime where a breach of the household has occurred. The majority of both old and new construction homes do not include “safe” or “storm” rooms which are designed to provide a safe refuge for individuals, families and their pets during these types of events.

Prior to the development of the present invention, most individuals and families had few choices in obtaining a safe shelter in which to provide themselves with protection during a severe weather or burglary event. For example, underground shelters are expensive to build and maintain, and due to the infrequency of such damaging storm and criminal events, result in a large cost and expense being literally sunk in the ground. Other above ground shelters required expensive fabrication and construction costs not to mention the requirement of additional real estate or space in which to construct the safety shelter. For existing homes, apartments, condominiums and other limited space environments, the costs of adding on to such structures is typically prohibitive and in many situations impossible. As such, occupants in these types of homes are extremely vulnerable to severe weather events and do not have the option of building adequate storm shelters.

As such, there is a need in the art for providing a shelter that is capable of being installed in existing homes and buildings that does not require additional space or construction to accommodate the shelter. There is a need for a safety shelter which can be easily assembled in modular fashion with existing building materials and easily be adapted to accommodate a variety of existing spaces in the home or building in which it is to be installed. There is a need in the art for a safety shelter that does not require the individual and/or family members to leave their home, building or premises in which to gain access to the safety shelter.

### SUMMARY OF THE INVENTION

According to one aspect, the present invention comprises a modular safety shelter including one or ceiling panels connected to one or multiple sidewall panels that are installed in an existing closet or space inside of an existing structure, which may generally be referred to herein as an “enclosure.” A door is connected to a sidewall panel with hinges, which allow the door to open and close as desired by the user. The door may include a door handle a vent with a vent shield attached to the interior surface of the door and latching means as well as deadbolt locking mechanisms and latch bolts for additional security. The sidewall panels and ceiling panel include flange sections, which allow the panels to mate together and secured together to form the safety enclosure. The sidewall panels and ceiling panels may also be connected to existing wall studs or wall cement masonry units (CMU) blocks depending on the existing space construction into which the safety shelter is installed.

According to another aspect, the modular safety shelter includes one or more air vents and a light source for providing light to the occupants within the shelter when the shelter is in use. A fan may also be included within the safety shelter to provide air circulation within the shelter as well as to propagate air transfer through the shelter vent(s) and the outside environment. According to another aspect, a safe is integrated into at least one sidewall panel, which allows the user to securely store items in the safe attached directly to the safety shelter.

It is a primary objective of the invention to provide individuals with safe and versatile shelter that may be installed in existing homes and dwellings without requiring additional space or construction for installation. It is a primary objective of the invention to provide individuals with a structurally safe enclosure for protection from storm airborne storm debris, tornadoes and severe weather events, and as a safe room from intruders.

In this respect, before explaining the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of one embodiment of the safety shelter invention disclosed herein;

FIG. 2 is a frontal view depicting the interior of the safety shelter according to an embodiment of the invention disclosed herein;

FIG. 3 is a top perspective view of the safety shelter installed in an existing space within existing construction according to one embodiment of the invention disclosed herein;

FIG. 4 is a frontal view of the safety shelter with a light source, a fan and a safe integrated with the safety shelter according to one embodiment of the invention disclosed herein; and,

FIG. 5 is a front plan view of the interior side of the door to the safety shelter with a vent cover, latch bolts and door handle lever guard according to one embodiment of the invention disclosed herein.

### DETAILED DESCRIPTION OF THE INVENTION

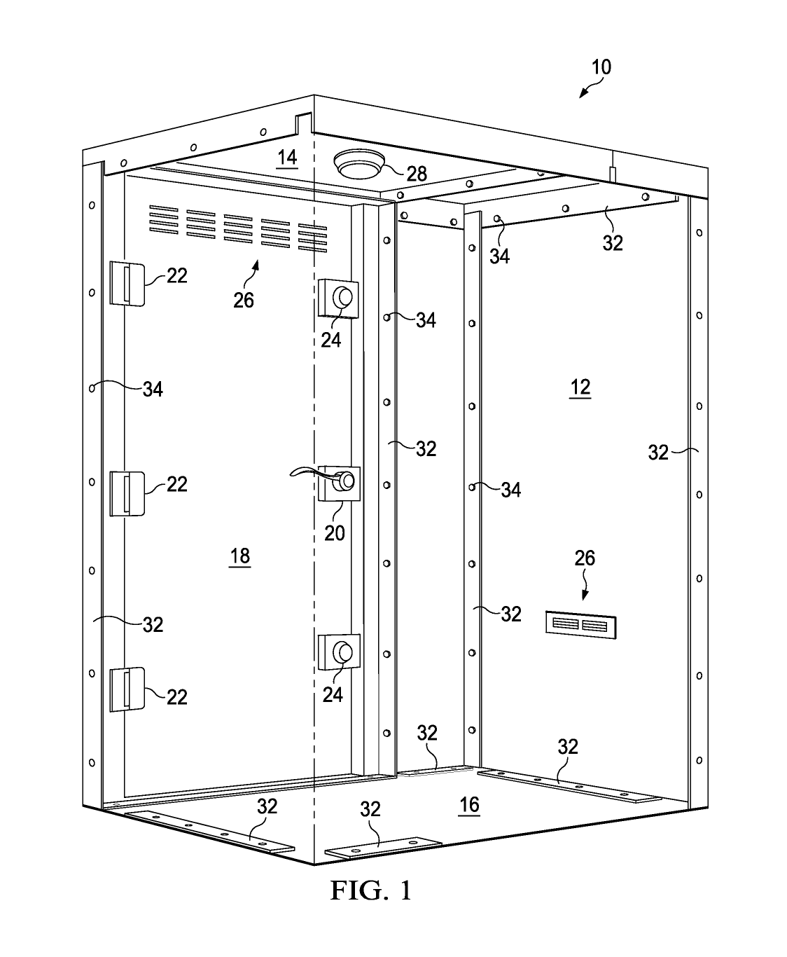

Turning to FIG. 1, there is disclosed a safety shelter 10 which is comprised of sidewall panels 12, a ceiling panel 14, and a door 18. The sidewall panels 12 and ceiling panel 14 include flanges 32 which are utilized to provide connection points between the panels. In the disclosed embodiment, the flanges are substantially straight, angled, bent or otherwise positioned, as appropriate, for mating with another ceiling and/or sidewall panel and include dimensionally spaced holes through which connectors 34 are utilized to connection the sidewall panels 12 and ceiling panel(s) 14 securely together. Connectors 34 may include bolts, nuts, pins, and/or other threaded connector devices as known in the art. In some embodiments, sidewall panels 12 and one or more ceiling panels 14 are connected by welding the flanges 32 together or by other connector means as known in the art. The number and size of sidewall panels 12 and ceiling panels 14 required for installation and construction of the shelter 10 is determined by the size of the shelter 10 desired by the user and/or the dimensional limitations of the existing closet or space within which the shelter 10 is to be assembled.

Door 18 is attached to a sidewall panel 14 by hinges 22. Door latch/handle 20 is provided with typical latching hardware to enable the user to open and shut door 18. Locks 24 may also be utilized to provide additional security for the occupant while the shelter 10 is being used. Vent 26 is depicted with a vent in a sidewall panel 12 and the door 18. One or more vents 26 may be installed and located as desired by the user or as dictated by the installation environment. Light source 28 is shown attached to ceiling panel 14. One or more lights sources 28 may be attached permanently or semi-permanently by magnetic or other detachably securable means and located anywhere within the interior of shelter 10 as desired the user or as dictated by the construction environment.

In the disclosed embodiment, the sidewalls 12 may be attached to existing floor 16 by connectors such as bolts, nails, screws or other attachment means as known in the art. Likewise sidewall panels 12 and ceiling panel 14 may be attached to the existing structure surrounding the shelter 10 such as an interior closed or other similar space in an existing home by connectors such as bolts, nails, screws or other attachment means as is known in the art. In this manner, the shelter is easily installed within existing structural space of a home, dwelling or other structural enclosure thereby strengthening the overall integrity of the space while providing an armored interior shelter 10 for the user.

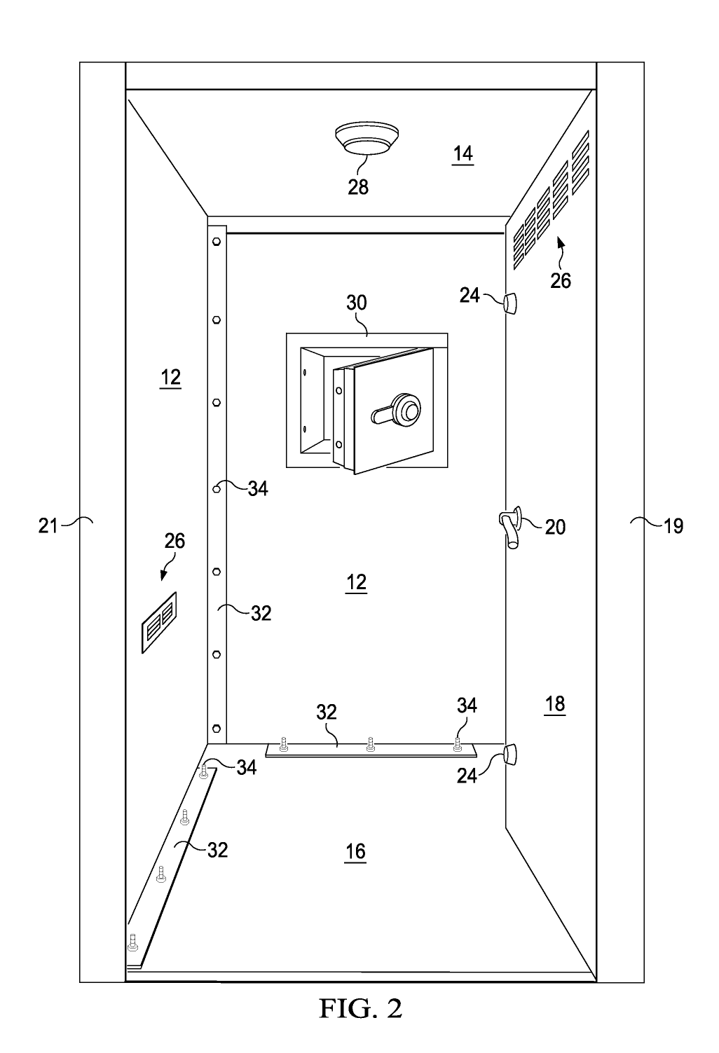

FIG. 2 depicts a frontal view of the shelter 10 with door 18 in the open position. In the depicted embodiment, a safe 30 is shown integrated into sidewall panel 12 opposite the door 18. Safe 30 provides a secure storage space for important documents and other valuables. The integration of safe 30 into a portion of shelter 10 provides an additional layer of protection from theft as any would be burglar would have to break into the shelter 10 before access to safe 30 would be possible. As such, shelter 10 also acts to provide an additional deterrent to a burglar or other person without permission to access safe 30. Hinge gap plate 19 and door stop plate 21 are depicted and serve two main functions, namely to provide a secure covering for the door hinges and door latch plate so as to prevent or inhibit access to the hinges and door latch plate by persons outside of the shelter 10 and to provide an improved aesthetic appearance which acts to blend the shelter's appearance with the existing closet or other enclosure in which the shelter 10 has been installed. Integrated and formed with door stop plate 21 are dimensionally spaced slots into which the door handle 20 bolt and security dead bolts 24 are inserted when the door 18 is closed by a user and the bolts (not shown) are actuated to secure the door 18 in a closed position.

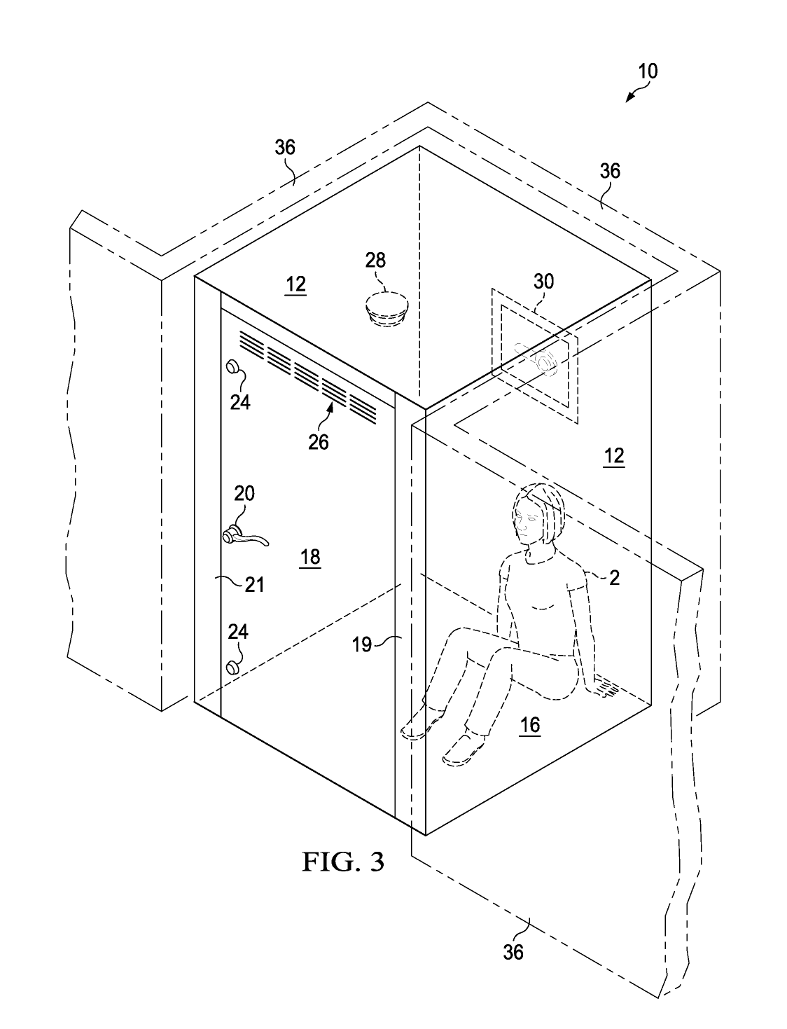

With reference to FIG. 3, an embodiment of the shelter 10 is shown while in use by a user 2. In this depiction, the shelter 10 is shown installed in an existing closet or interior space formed by walls 36. As previously described herein, an embodiment of the shelter 10 may be connected or otherwise attached to existing floor 12 and walls 36 to provide additional structural support to the shelter 10 as well as existing walls 36. In one embodiment, the shelter 10 is secured to floor 12 or other foundation element in the existing construction by anchor bolts or other means as known in the art. In one embodiment, the shelter 10 is assembled together as previously described herein and is not other wise connected or attached to the existing walls 36 or other existing structure surrounding the shelter 10 as the shelter 10 is capable of self support as designed and constructed.

A user 2 is shown sitting on the floor 12 in shelter 10 while weathering a storm or burglary event. After entry, the user may secure the door by actuating locks 24 and any locking mechanism that is integrated with the door latch/handle/lever 20. After the event transpires, the user 2 may simply unlock the locks 24 actuate the door latch/handle 20 and exit the shelter 10. Vent 26 provides for airflow and circulation in and out of the shelter and provides a point for the user to safely observe any activity occurring outside of the shelter 10 as well as a point by which the user may safely speak with personnel outside of the shelter 10. Light source 28 provides lighting to the user 2 while he/she awaits the weather or intrusion event to transpire and the arrival of emergency/police personnel. Vent 26 also provides for the transmission and reception of electronic wireless signals allowing the user 2 to communicate by electronic means with emergency/police personnel while the user 2 is inside of the shelter 10.

In one embodiment, the sidewall panels 12, ceiling panel 14 and door 18 are constructed of 3/16 inch steel plate which in testing withstood and deflected both .45 caliber and 9 mm handgun full metal jacket rounds fired at such an embodiment at point blank range four feet from the panel. The shelter meets FEMA F-5 projectile and multi-occupancy standards including debris impact protection from high winds and safety ventilation for occupants while the shelter 10 is in use. In an embodiment, door 18 may be sized to meet Americans with Disabilities Act requirements to accommodate a wheel chair and other assistive equipment for the user 2.

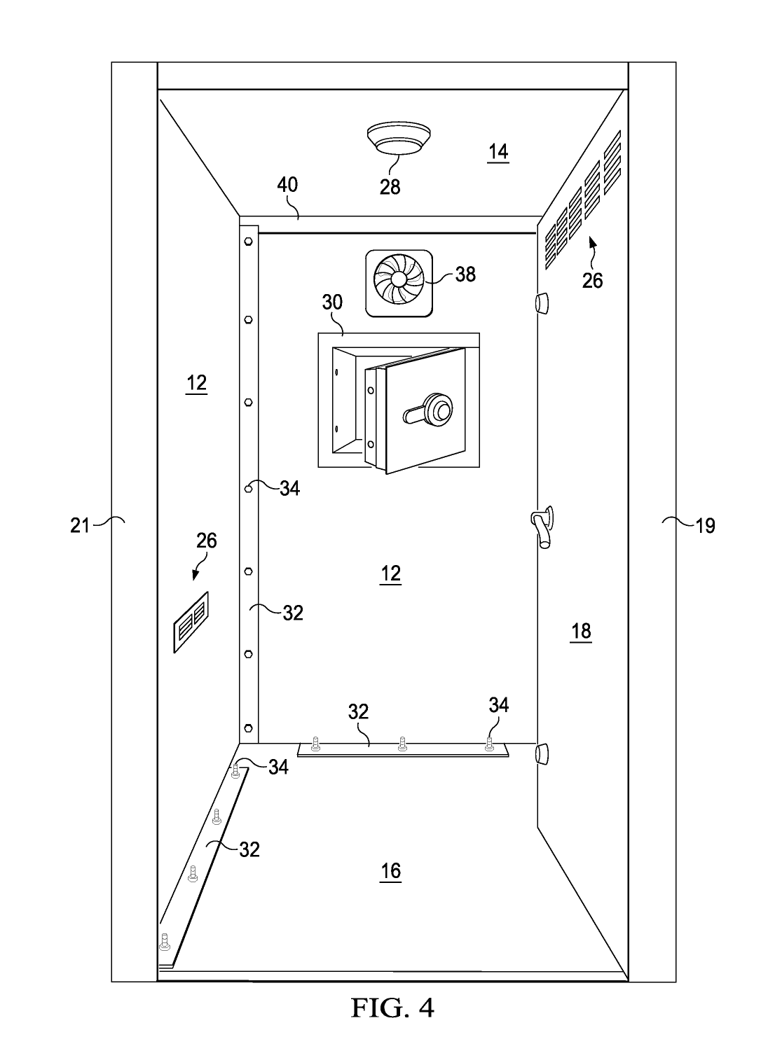

FIG. 4 is a depiction of a frontal view of an embodiment of the present invention with a fan 38 shown installed into a sidewall panel 12 opposite the door 18. Fan 38 provides improved forced air circulation within the shelter 10 interior as well as enhanced fresh air exchange with the outside environment via vents 26. Fan 38 may be detachably secured by the user to any location within the shelter 10 as desired. In one embodiment, fan 38 is positioned over vent 26 to improve airflow between the interior of the shelter 10 with the outside environment. In the depicted embodiment, one or more flange covers 40 is shown inside the shelter 10 which acts to cover the exposed flanges 32 and provide a more pleasing aesthetic appearance to the user 2. Flange covers 40 may be utilized anywhere within the interior of the shelter 10 to cover exposed flanges 32 and connectors 34. Flange covers 40 may be attached to the exposed flanges 32 or connectors 34 by such connection means as known in the art including, but not limited to, hooks, screws, nails, rivets, welding, threaded type connectors, hook and loop, and/or magnets.

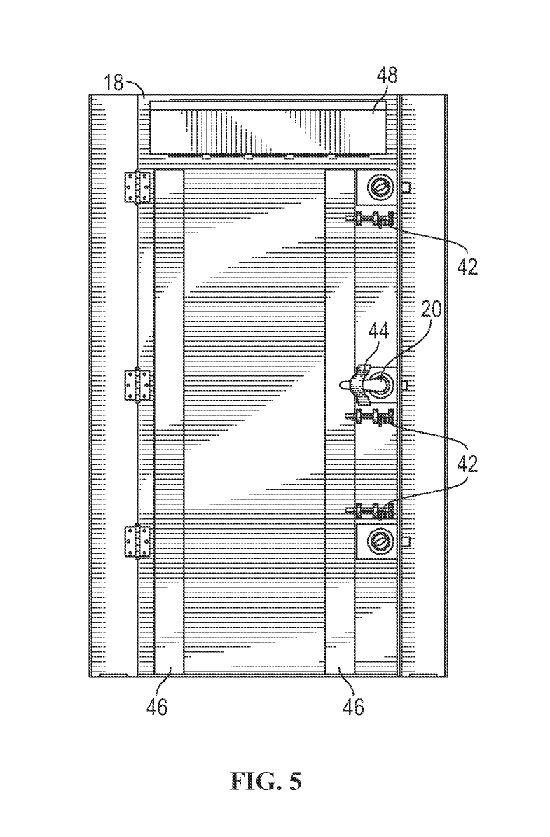

Turning to FIG. 5, an embodiment depicting a plan view of the interior side of door 18 is shown. In this embodiment, latch bolts 52 are welded or otherwise secured to the door 18 increasing the security and strength of door 18 to withstand wind, flying objects striking the exterior of door 18 during severe storm, wind and tornado events. Latch bolts 52 are easily moved into a locked configuration by the occupant of the shelter 10 by sliding the bolt through a corresponding hole or latch orifice preformed in or on the interior surface of door stop plate 21. In the event deadbolts 24 (shown in FIGS. 1 and 2) are compromised or otherwise rendered not operational, latch bolts 52 allow the occupant 2 to easily and quickly secure the door from the interior of the shelter 10 until assistance arrives from law enforcement or other security personnel.

A door latch/handle guard 54 is also depicted in FIG. 5. Door latch/handle guard 54 is welded or otherwise securely attached to the interior surface of door 18 and surrounds a portion of the door latch/handle 18 and acts to protect the occupant 2 from the door latch/handle being dislodged and propelled into the interior of the shelter 10 during a storm or home invasion event. If debris strikes, or a home invader attempts to dislodge, the corresponding door latch/handle 20 located on the exterior of door 18 the door latch/handle guard 54 acts to substantially prevent the interior door latch/handle from becoming dislodged and propelled into the interior of the shelter 10 thereby posing a risk of injury to the occupant 2 located inside the shelter 10. In the embodiment depicted in FIG. 5, the door 18 also includes a vent shield 58 secured to the interior surface of the door 18 and which extends away from and substantially covers vent 26. Vent shield 58 allows air to circulate into and out of the shelter 10 via vent 26 while substantially blocking the ability of a person standing outside of the shelter 10 from peering into or sighting the occupant of the shelter 10 while the shelter 10 is in use. Vent shield 58 also provides additional protection from flying debris or other materials which may impact or be inserted through the vent 26 from striking an occupant 2 inside the shelter 10 as vent shield 58 would deflect any such debris or object in the vertical direction towards the floor 16. Also depicted in FIG. 5 are impact channels 56 which are welded to or otherwise secured or formed into door 18. Impact channels 56 act to provide additional structural strength to door 18 in resisting debris and other impact forces applied to door 18 during weather or home invasion events.

The terms, descriptions and figures used herein are set forth by way of illustration only and are not meant as limitations. Those skilled in the art will recognize that many variations of the clamp assembly are possible within the spirit and scope of the invention in which all terms are meant in their broadest, reasonable sense unless otherwise indicated. The description and utilization of the clamp assembly set forth herein is not meant to be limited to any particular industry or use, and those of skill in the art will recognize the disclosed invention may be applied in other industrial arts such as the medical arts, mechanical arts and technological arts. Any headings utilized within the description are for convenience only and have no legal or limiting effect. Additional disclosure in the form of brochures and construction drawings with dimensions are included and hereby incorporated into the specification by reference as if fully set forth at length herein.

I claim:

1. A shelter, comprising:
at least two sidepanels and a ceiling panel secured together with connectors via flanges attached to the sidepanels and the ceiling panel;
a door detachably secured to a sidepanel with one or more hinges attached to a sidepanel and the door; and,
the shelter is positioned within an enclosure.

2. The shelter of claim 1 further comprising:
a lock attached to the door.

3. The shelter of claim 1 further comprising:
a fan attached to an interior surface of the shelter.

4. The shelter of claim 1 further comprising:
a latch bolt attached to the door.

5. The shelter of claim 1 further comprising:
a safe attached to a sidepanel of the shelter.

6. The shelter of claim 1 further comprising:
a light attached to an interior surface of the shelter.

7. The shelter of claim 1 further comprising:
a door latch/handle guard attached to the door.

8. The shelter of claim 1 further comprising:
a vent provided in the door.

9. The shelter of claim 1 further comprising:
a vent shield attached to the interior of the door.

10. The shelter of claim 1 further comprising:
a flange cover positioned over at least one flange of the shelter.

11. The shelter of claim 1 further comprising:
an impact channel attached to the door.

12. The shelter of claim 1 wherein at least one sidepanel is secured to the existing floor of the enclosure.

13. The shelter of claim 1 further comprising:
a hinge gap plate.

14. The shelter of claim 1 further comprising:
a door stop plate.
